(19) United States
(12) Patent Application Publication
(10) Pub. No.: US 2023/0245088 A1
(43) Pub. Date: Aug. 3, 2023

(54) SYSTEM AND METHOD FOR ENABLING MULTIPLE MODES CASHLESS TRANSACTIONS OVER KIOSK

(71) Applicant: Vendekin Technologies Private Limited, Pune (IN)

(72) Inventors: Aroon Ashish KHATTER, Pune (IN); Ajit Sukumaran Nair, Pune (IN); Habiballa G. Rajbar, Pune (IN); SK Saiful Alam Islam, Pune (IN)

(21) Appl. No.: 18/102,991

(22) Filed: Jan. 30, 2023

(30) Foreign Application Priority Data
Jan. 31, 2022 (IN) 202221005260

(51) Int. Cl. G06Q 20/18; G06Q 20/32

(52) U.S. Cl. CPC G06Q 20/18; G06Q 20/327

(57) ABSTRACT

A system for enabling multiple modes for cashless transactions over a self-service kiosk. The system includes a user device and a self-service kiosk. The self-service kiosk includes a vending machine controller, a keypad and a multi-cashless device. The multi-cashless device is configured to communicate with the user device to receive transaction data. The multi-cashless device is configured to toggle between a set of payment modes depending upon the transaction data, wherein each payment mode, from the set of payment modes, corresponds to a payment module from a set of payment modules associated with the multi-cashless device.

### CROSS REFERENCE TO RELATED APPLICATION AND PRIORITY

The present application claims priority from Indian Patent Application no. 202221005260 filed on 31 Jan. 2022, incorporated herein by a reference.

### TECHNICAL FIELD

The present disclosure relates to a self-service kiosk. More particularly this invention relates to a pluggable hardware for enabling multimode cashless transactions over a legacy self-service kiosk.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

In the conventional art of kiosk machines, a Vending Machine Controller (VMC) has only two basic addresses on which communication with a cash and cashless device can be performed. Most of the VMC work on a single channel address implying that only one device can work at a time. As a result, the kiosk machine owner can install only one cashless device in the kiosk machine. However, nowadays, there are multiple electronic payment devices available for enabling cashless payment. For example, magnetic tape card readers, RFID card readers, QR code scanners, NFC device are some of the electronic payment devices available for cashless payment. However, due to the limitation of the legacy kiosk machines, only one of these cashless payment hardware can be installed in the kiosk machine. As a result, if the kiosk machine only supports the cashless transactions via credit/debit cards, and if the user operating the kiosk machine does not have a physical debit/ credit card but is equipped with other cashless transaction facilities like e-wallets, internet banking, phone banking etc., then the user may not be able to conduct the transaction on the kiosk device.

Another limitation of the existing kiosk machines is that if a physical card is not used for payment at the kiosk machine, and the payment is done using online payment channels, a card not present charge is applicable on each transaction. However, these charges can be avoided by integrating an additional hardware that can enable the kiosk machine to accept payment through tap-and-pay method.

Thus, there is a need of developing a hardware unit and a software/ firmware that can be integrated into existing kiosk machine for enabling the kiosk machine to accept cashless payment through multiple cashless payment modes.

### SUMMARY

This summary is provided to introduce concepts related to a system and method for enabling a multi cashless mode of payment over a legacy kiosk machine and the concepts are further described below in the detailed description. This summary is not intended to identify essential features of the claimed subject matter, nor it is intended for use in determining or limiting the scope of the claimed subject matter.

The present disclosure relates to a system and a method for enabling multiple modes for cashless transactions over a self-service kiosk. The system comprising a user device and a self-service kiosk. Further, the self-service kiosk is comprising a vending machine controller, a keypad, and a multi-cashless device. The multi-cashless device is configured to communicate with the user device to receive transaction data. The multi-cashless device comprises a memory and a processor. The processor is configured to execute programmed instructions stored in the memory for performing various steps. The multi-cashless device is configured to toggle between a set of payment modes depending upon the transaction data, wherein each payment mode, from the set of payment modes, corresponds to a payment module from a set of payment modules associated with the multi-cashless device. Further, the multi-cashless device is configured to transmit an activation signal to the vending machine controller upon completion of a payment. The vending machine controller is configured to unlock the keypad. Furthermore, the multi-cashless device is configured to activate a relay card to press one or more keys of the keypad based on the transaction data to dispense the one or more products.

### BRIEF DESCRIPTION OF DRAWINGS

The detailed description is described with reference to the accompanying Figures. In the Figures, the leftmost digit(s) of a reference number identifies the Figure in which the reference number first appears. The same numbers are used throughout the drawings to refer to features and components.

FIG. 1 illustrates a network architecture of a system for enabling multiple modes for cashless transactions over a self-service kiosk, in accordance with an embodiment of the present subject matter.

FIG. 2 illustrates an interface of a multi cashless device and other modules in the self-service kiosk, in accordance with an embodiment of the present disclosure.

FIG. 3 illustrates a workflow diagram for cashless payment over the self-service kiosk, in accordance with an embodiment of the present subject matter.

The embodiments herein will be understood from the following detailed description with reference to the drawings, in which the reference numerals indicate:

| Reference numeral | Component |
|---|---|
| 100 | system |
| 101 | server |
| 102 | network |
| 103 | user device |
| 104 | self-service kiosk |
| 105 | Vending Machine Controller |
| 106 | display |
| 107 | keypad |
| 110 | multi-cashless device |
| 701 | cash acceptor unit |
| 205 | relay card |
| 201 | CPU Card |
| 202 | switch |
| 203 | card reader |
| 204 | a set of ports |

### DETAILED DESCRIPTION

Reference throughout the specification to “various embodiments,” “some embodiments,” “one embodiment,” or “an embodiment” means that a particular feature, structure, or characteristic described in connection with the embodiment is included in at least one embodiment. Thus, appearances of the phrases “in various embodiments,” “in some embodiments,” “in one embodiment,” or “in an embodiment” in places throughout the specification are not necessarily all referring to the same embodiment. Furthermore, the particular features, structures or characteristics may be combined in any suitable manner in one or more embodiments.

The present disclosure relates to a system and a method for enabling multiple modes for cashless transactions over a self-service kiosk. The system comprising a user device, a server, and a self-service kiosk. The user device is configured to communicate with the server through a network. The self-service kiosk comprises a Vending Machine Controller, a display, a keypad, a relay card, a cash acceptor unit, and a card reader. Further, a multi-cashless device is retrofitted into the self-service kiosk.

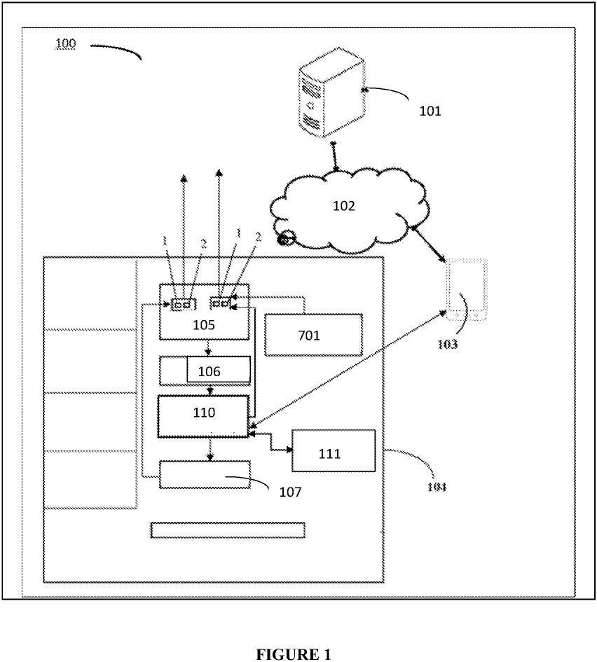

Now referring to FIG. 1, a network architecture of a system for enabling multiple modes for cashless transactions over a self-service kiosk is illustrated, in accordance with an embodiment of the present subject matter.

In one embodiment, a system 100 for enabling multiple modes for cashless transactions over a self-service kiosk 104 is disclosed. The system 100 may comprises a user device 103, a server 101, and a self-service kiosk 104. The user device (103) may be configured for generating transaction data, based on inputs received from a user of the user device (103). The user device 103 may be configured to communicate with the server 101 through a network 102. The self-service kiosk 104 may comprise a Vending Machine Controller 105, a display 106, a keypad 107, a relay card 205, a cash acceptor unit 701, a card reader 203 and a multi-cashless device 110. The multi-cashless device 110 may be retrofitted into the self-service kiosk 104. The multi-cashless device 110 may be configured to communicate with the user device 103 using a short-range communication protocol. The multi-cashless device 110 may comprise a CPU Card 201. The CPU Card 201 may comprise a processor, memory, and a set of ports 204. The processor may be a switch 202. The processor may be configured to execute programmed instructions stored in the memory for performing various steps. The multi-cashless device 110 may be configured to toggle between a set of payment modes depending upon the transaction data, wherein each payment mode, from the set of payment modes, corresponds to a payment module from a set of payment modules associated with the multi-cashless device (110). The multi-cashless device 110 may be configured to transmit an activation signal to the vending machine controller (105) upon completion of a payment. The vending machine controller (105) may be configured to unlock the keypad (107). The multi-cashless device 110 may be configured to activate a relay card (205) to press one or more keys of the keypad (107) based on the transaction data to dispense the one or more products.

It must be noted that each payment mode, from the set of payment modes, corresponds to a payment module from a set of payment modules associated with the multi-cashless device 110. The set of payment modules may comprise magnetic tape card readers, RFID card readers, QR code scanners, NFC device.

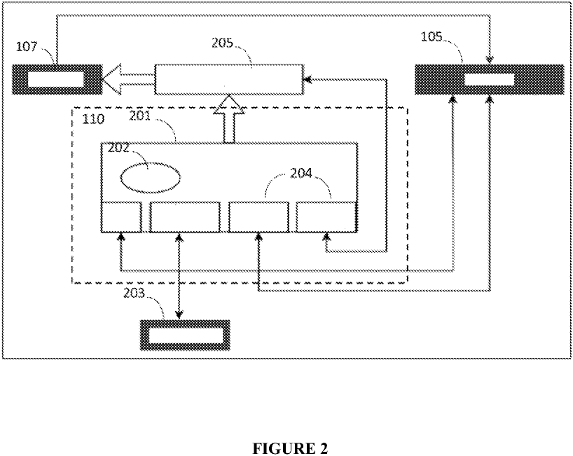

The self-service kiosk 104 may be any type of machine for dispensing products or provisioning services based on inputs received from a user. The self-service kiosk 104 may be enabled with a VMC 105, a display 106, a keypad 107, a cash acceptor unit 701. The VMC 105 may be communicatively coupled with the cash acceptor unit 701.The cash acceptor unit 701 is configured to accept cash for vending products stored in the self-service kiosk 104. Further, a multi cashless device 110 may be retrofitted to the self-service kiosk104. The multi cashless device 110 may be enabled to communicate with the user device 103 using a short-range communication protocol such as Bluetooth. The short-range communication protocol may be selected from a group comprising, Bluetooth communication protocol, Near Field Communication (NFC), Radio Frequency (RF) protocol, an infra-red (IR) protocol, and ZigBee protocol. Further, the user device 103 may be communicatively coupled to the server 101 through the network 102. The server 101 may be configured to enable online payment of products to be dispensed from the self-service kiosk 104, thereby facilitating cashless transactions at the self-service kiosk 104 through the user device 103. The transaction data may comprise a type of transaction selection and user’s product selection. The block diagram of the multi cashless device 110 for enabling cashless transactions is further described in FIG. 2.

Referring now to FIG. 2, the interface of the multi cashless device 110 with other modules in the self-service kiosk 104 is illustrated, in accordance with an embodiment of the present disclosure. The multi cashless device 110 may be retrofitted into the self-service kiosk 104. The Multi cashless device 110 may comprise a CPU Card 201. The CPU card 201 may comprises a memory, a processor, and a set of ports 204. The processor may be the switch 202. The switch 202 may be a Hardware switch or a Software switch. The set of ports 204 may comprise a main MDB, a card reader MDB, a DEX connector, a keypad connector.

The set of ports 204 may enable the CPU card 201 to establish communication between VMC 105, a relay card 205, and a set of payment modules to enable a user of the self-service kiosk 104 to pay using different payment modes. Further, the switch 202 may be enabled for toggling between the different payment modes enabled by a set of payment modules depending upon the type of transaction selected by the user of the self-service kiosk 104.

In one embodiment, the switch 202 may be the hardware switch. The switch 202 may be the software switch. The hardware switch may be configured to toggle between the set of payment modules so that at a time one payment module can be the primary device to communicate with VMC 105. The software switch may scan the addresses and determine if the set of payment modules can communicate with VMC 105 through software as well.

In addition to switching, the multi-cashless device 110 passively sniffs the data transmission between the primary device and VMC 105. Regardless of switching, the multi cashless device 110 may be responsible for pressing the keys that the VMC 105 recognises as being used to vend a specific compartment.

The switching (software/ hardware) may be driven by the user device application through protocol so that device selection to communicate with VMC 105 may be determined. This seamless switching is enabled to deliver a superior consumer experience.

The multi cashless device 110 might be a hardware-based solution that allows a self-service kiosk to run two cashless devices at once. The card reader may be inserted as device 2 and the multi-cashless device 110 as device 1.

It’s possible that the self-service kiosk 104 may be using an older version of MDB (4.3). The self-service kiosk 104 may be one of the existing units on the market. Any self-service kiosk can be retrofitted with the multiple cashless device 110 without requiring any changes to it and continue to function smoothly.

The CPU card 201 may be the master card which is the main controller module. The CPU card 201 may perform the following functions through the set of ports 204. The Main MDB may communicate with the VMC 105. The card reader MDB may communicate for data check. The switch relay may enable switching between card reader and multi cashless device 110. The DEX connector may initiate DEX communication with the VMC 105 and collect data from it. The keypad connector may pass key pressing signal action to VMC 105 to enable automated dispensation of the product. The key signal may be sent to the relay card for actual key press on the machine. Furthermore, the relay card may be responsible for receive the key signal from CPU card 201 and mimic the actual key press with the relay press contact

In one embodiment, the type of transaction and product may be selected by the user using his user device 103. For example, the multi-cashless device 110 may be communicatively coupled with a card reader 203 and an NFC device using the first port of the set of ports 204 available in the CPU card 201. The user may select card payment mode and available products. This selection may be communicated to the multi cashless device 110 through short range communication such as Bluetooth. Based upon the selection, the multi cashless device 110 may operate the switch 202 to toggle between the payment modes and activate the card reader linked with card payment mode in order to accept the card payment before dispensing the product. Once the payment is complete, an activation signal may be transmitted by the CPU card 201 to the VMC 105 through the second port set of ports 204. Upon receipt of the activation signal, the VMC 105 may release the keypad 107, such that the keys of the keypad can be pressed to make selection of the product to be dispensed from the self-service kiosk104. Further, user’s product selection may be transmitted by the CPU card 201 to the relay card 205. The relay card 205 is retrofitted in the keypad 107 to press the keys of the keypad 107.

It must be noted that when the Keypad 107 is in locked state and if the user of the self-service kiosk 104 presses multiple keys on the keypad 107, product vending instructions are not accepted by the VMC 105. Conventionally, the Keypad 107 is released/ unlocked only when cash is accepted through the cash acceptor. Thus, the activation signal comprises a subset of instructions to release the keypad 107, such that the keys of the keypad can be pressed to make selection of the product to be dispensed from the self-service kiosk 104. Furthermore, once the payment is complete, the CPU card 201 may transmit signals to the relay card 205. The signal may correspond to the product selected by the user. The relay card 205 may be retrofitted into the keypad 107 of the self-service kiosk 104. The relay card 205 may auto-press keys on the keypad 107 upon receipt of the signal from the CPU card 201 thereby dispensing the product.

In another embodiment the method for enabling multi-cashless modes for facilitating transactions over a self-service kiosk 104 comprising following steps:

In step one a multi-cashless device 110 may receive transaction data from a user device (103). The self-service kiosk (104) may comprise a vending machine controller (105), a keypad (107) and a multi-cashless device (110). The multi-cashless device (110) may be configured to communicate with the user device (103) to receive the transaction data The self-service kiosk 104 may comprise a Vending Machine Controller 105, a display 106, a keypad 107, a relay card 205, a cash acceptor unit 701, and a card reader 203. The multi-cashless device 110 may be retrofitted into the self-service kiosk 104. The multi-cashless device 110 may be configured to communicate with the user device 103 using a short-range communication protocol. The transaction data may comprise a type of transaction selection and user’s product selection

In the second step a switch 202 may toggle between a set of payment modes depending upon the type of transaction selected by the user on the user device 103. The multi-cashless device 110 may comprise a CPU Card 201. The CPU Card 201 may comprise a memory, a processor, and a set of ports 204. The processor may be a switch 202. The switch 202 may be enabled for toggling between a set of payment modes depending upon the type of transaction selected by the user on the user device 103. Each payment mode, from the set of payment modes, corresponds to a payment module from a set of payment modules associated with the multi-cashless device 110.

In the third step the CPU card 201 may transmit an activation signal of payment completion to the Vending Machine Controller 105.

In the last step the CPU card 201 may send the user’s product selection to the relay card 205 after completion of payment. The relay card 205 is retrofitted in the keypad 107 to press the keys of the keypad 107.

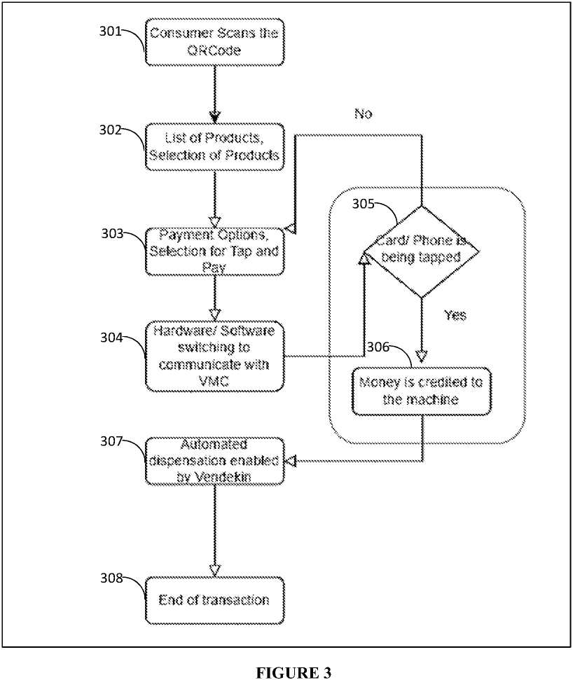

The steps for vending products from the self-service kiosk 104 are further elaborated with respect to the flow diagram of FIG. 3.

Now referring to FIG. 3, the workflow diagram 300 for cashless payment over the self-service kiosk 104 is illustrated, in accordance with an embodiment of the present subject matter.

At step 301, a customer at the self-service kiosk 104 may scan a QR code affixed to the self-service kiosk 104. The scanning of the QR code may activate a mobile application, corresponding to the self-service kiosk 104, over the user device 103.

At step 302, the server 101 that is communicatively coupled with the user device 103 through the network 102 may enable the used device 103 to display the list of products available for dispensing at the self-service kiosk 104. The user may select one or more products from the list of products.

At step 303, the user may select a payment mode from the list of payment modes displayed over the user device 103. This list of payment modes may be fetched from the server 101.

At step 304, the multi cashless device 110 may receive the details of the product selected by the user and the payment mode selected by the user from the user device through short range communication such as Bluetooth or Wi-Fi. In one example, the user may select Tap-and-Pay as the mode of payment. Based on the payment mode (Tap-and-Pay) selection made by the user, the switch 202 at the CPU card 201 may toggle between the available payment modes and activate the NFC device connected to the CPU card 201 through the set of ports 204 for accepting the payment through the Tap-and-Pay mode.

At step 305, if the payment is not received from the user through the Tap-and-Pay mode, the process flow is redirected to step 303.

At step 306, in case the CPU card 201 detects receipt of payment, the paid amount is credited to the self-service kiosk 104 and an activation signal may be transmitted by the CPU card 201 to the VMC 105 through the set of connection ports 204.

At step 307, upon receipt of the activation signal, the VMC 105 may release the keypad 107, such that the keys of the keypad can be pressed to make selection of the product to be dispensed from the self-service kiosk 104. Furthermore, once the payment is complete, the CPU card 201 may transmit signals to the relay card 205. The signal may correspond to the product selected by the user. The relay card 205 may be retrofitted into the keypad 107 of the self-service kiosk 104. The relay card 205 may auto-press keys on the keypad 107 upon receipt of the signal from the CPU card 201 thereby dispensing the product.

At step 308, the transaction process is completed upon detection of successful dispensing of products.

The aforementioned illustrated embodiments offer the following advantages over the conventional kiosk machines, which may include but are not limited to:
The present disclosure solves the need for a system to run two or more cashless devices simultaneously to enable the user to swiftly toggle between various payment options and thereby enjoy a superior consumer experience.
Further the present disclosure provides a system that may work seamlessly with machines that are running on older versions (< 4.3) of MDB and those machines that are already deployed in the market without making any changes to the existing setup.

The foregoing description shall be interpreted as illustrative and not in any limiting sense. A person of ordinary skill in the art would understand that certain modifications could come within the scope of this disclosure. For limiting the scope of the invention, a subsequent Complete Specification will be filed to determine the true scope and content of this disclosure.

Although implementations for the system and method for enabling a multi cashless mode of payment over a legacy self-service kiosk have been described in language specific to structural features and/or methods, it is to be understood that the appended claims are not necessarily limited to the specific features or methods described. Rather, the specific features and methods are disclosed as examples of implementations for the system and method for enablement of the device for kiosk machines to communicate with cashless transaction devices.

1. A system for enabling cashless transactions over a self-service kiosk, the system comprising:
a user device, configured for generating transaction data, based on inputs received from a user of the user device;
a self-service kiosk comprising a vending machine controller, a keypad and a multi-cashless device, wherein the multi-cashless device comprises a memory and a processor, wherein the processor is configured to execute programmed instructions stored in the memory for:
receiving the transaction data from the user device;
processing the transaction data to determine a target payment mode, from a set of payment modes, associated with the multi-cashless device, wherein each payment mode, from the set of payment modes, corresponds to a payment module from a set of payment modules associated with the multi-cashless device;
activating a target payment module, from a set of payment modules, based on the target payment mode;
transmitting an activation signal to the vending machine controller upon completion of a payment through the target payment module, wherein the vending machine controller is configured to unlock the keypad upon receipt of the activation signal; and,
activating a relay card to press one or more keys of the keypad based on the transaction data to dispense the one or more products.

2. The system as claimed in claim 1, wherein the user device is configured to communicate with a server through a network, wherein the server is configured to provide a list of available products and a list of payment modes when requested by the user device.

3. The system as claimed in claim 1, wherein the transaction data comprises a type of transaction selection and user’s product selection.

4. The system as claimed in claim 1, wherein the self-service kiosk comprises a display, the relay card, a cash acceptor unit, and a card reader, wherein the multi-cashless device is retrofitted on the self-service kiosk.

5. The system as claimed in claim 1, wherein the vending machine controller is configured to control the cash acceptor, the display and keypad, wherein the relay card is retrofitted in the keypad to press the keys of the keypad.

6. The system as claimed in claim 1, wherein the cash acceptor unit is configured to accept cash and the card reader configured to be linked with card payment mode in order to accept the card payments.

7. The system as claimed in claim 1, wherein the multi-cashless device comprises a CPU Card, wherein the CPU card comprises the processor, the memory, and a set of ports.

8. The system as claimed in claim 1, wherein the set of ports enable the CPU card to establish communication between the VMC, the relay card, and the set of payment modules.

9. The system as claimed in claim 1, wherein the processor is configured to receive transaction data from the user device via short-range communication and activate a targeted payment module from a set of payment modules based on the payment mode selected by the user, wherein the short-range communication protocol selected from a group comprising, Bluetooth communication protocol, Near Field Communication (NFC), Radio Frequency (RF) protocol, an infra-red (IR) protocol, and ZigBee protocol.

10. A method for enabling cashless transactions over a self-service kiosk, the method comprising steps of:
generating a transaction data, wherein a user device is configured for generating transaction data, based on inputs received from a user of the user device;
receiving the transaction data from the user device at a multi-cashless device, wherein a self-service kiosk comprising a vending machine controller, a keypad and a multi-cashless device, wherein the multi-cashless device comprises a memory and a processor, wherein the processor is configured to execute programmed instructions stored in the memory for:
processing the transaction data to determine a target payment mode, from a set of payment modes, associated with the multi-cashless device, wherein each payment mode, from the set of payment modes, corresponds to a payment module from a set of payment modules associated with the multi-cashless device;
activating a target payment module, from a set of payment modules, based on the target payment mode;
transmitting an activation signal to the vending machine controller upon completion of a payment through the target payment module, wherein the vending machine controller is configured to unlock the keypad upon receipt of the activation signal; and,
activating a relay card to press one or more keys of the keypad based on the transaction data to dispense the one or more products.
